(19) United States
(12) Patent Application Publication
(10) Pub. No.: US 2013/0086635 A1
(43) Pub. Date: Apr. 4, 2013

(54) SYSTEM AND METHOD FOR COMMUNICATION IN A NETWORK

(71) Applicants: John Erik Hershey, Ballston Lake, NY (US); Bruce Gordon Barnett, Troy, NY (US); Michael Joseph Dell'Anno, Clifton Park, NY (US); Daniel Thanos, Stouffville (CA)

(72) Inventors: John Erik Hershey, Ballston Lake, NY (US); Bruce Gordon Barnett, Troy, NY (US); Michael Joseph Dell'Anno, Clifton Park, NY (US); Daniel Thanos, Stouffville (CA)

(73) Assignee: GENERAL ELECTRIC COMPANY, Schenectady, NY (US)

(21) Appl. No.: 13/249,346

(22) Filed: Sep. 30, 2011

(51) Int. Cl. G06F 21/00; G06F 15/16; G06F 11/00

(52) U.S. Cl. 726/3; 726/22; 726/25

(57) ABSTRACT

A method for providing secure communication in an electrical power distribution network includes detecting an enhanced threat level in the electrical power distribution network. A plurality of configuration command messages including information related to a common configuration command are received. The common configuration commands are certified if the plurality of configuration command messages have originated from a threshold number of command sites. The method further includes executing the certified configuration command.

### BACKGROUND

Embodiments of the present invention relate generally to power utility networks. More specifically, the embodiments relate to a system and method of communicating secure messages over networked systems in a power utility network.

A modern society is served by utilities that must function properly at almost all times. Proper functioning is typically expressed by reliability, availability, accountability, and certifiability, the latter term meaning the ability of a user of a utility to actively query and learn the status of the utility. In order to meet growing demands while providing reliability and efficiency, utilities, such as electric utilities, are developing and implementing technologies to create an intelligent infrastructure, such as a “smart grid” infrastructure of the power grid.

In order to realize an intelligent infrastructure, the Federal Energy Regulatory Commission (FERC), the federal entity partly responsible for oversight of interstate sales of electricity and wholesale rates of electricity, and a successor to the Federal Power Commission, has specified four priorities for the Smart Grid: (1) Cybersecurity, (2) Intersystem Communications, (3) Wide area situational awareness, and (4) Coordination of the bulk power system. FERC's first priority, cybersecurity, is motivated by recognition of the ever-increasing emergence of cyber threats. The insinuation of malware, either through accident or design, has become commonplace. The effects of digital malware vary and the effects on the overall network's health and efficiency range from nuisance to severely minacious. The spectrum of the cyber malefactor's intentions is also expanding from simple to sophisticated hacking and includes physical attacks that may damage, delay, or disable routine and proper functioning of the grid. It is worrisome but prudent to expect that cyber malefactors may eventually expand to practicing coordinated cyber terrorism.

In order to limit the potential damage of the cyber security threat, efforts are underway to enable awareness of potential threat events as well as their details and effects in order to harden the utility communication infrastructure both proactively and in response to incidents.

For these and other reasons, there is a need for the present invention.

### BRIEF DESCRIPTION

In accordance with an embodiment of the present invention, a method for providing secure communication in an electrical power distribution network is provided. The method includes detecting an enhanced threat level in the electrical power distribution network and receiving a plurality of configuration command messages including information related to a common configuration command. The method further includes certifying the common configuration command if the plurality of configuration command message have originated from a threshold number of command sites and executing the certified configuration command.

In accordance with another embodiment of the present invention, a communication system for an electrical power distribution network is provided. The communication system includes a threat response module to detect an enhanced threat level in the electrical power distribution network and a plurality of command sites for transmitting a plurality of configuration command messages including information related to a common configuration command to a host device. The host device is configured to certify the common configuration command if the plurality of configuration command messages have originated from a threshold number of command sites and execute the certified configuration command.

In accordance with yet another embodiment of the present invention, an apparatus for providing secure communications is provided. The apparatus includes at least one memory that stores computer executable instructions and at least one processor configured to access that at least one memory, wherein the at least one processor is configured to execute the computer executable instructions which include detecting an enhanced threat level in an electrical power distribution network. .The computer executable instruction further include receiving a plurality of configuration command messages including information related to a common configuration command, certifying the common configuration command if the plurality of configuration command messages have originated from a threshold number of command sites and executing the certified configuration command.

### DRAWINGS

These and other features, aspects, and advantages of the present invention will become better understood when the following detailed description is read with reference to the accompanying drawings in which like characters represent like parts throughout the drawings, wherein:

FIG. 1 is an electrical power distribution network in accordance with an embodiment of the present invention;

FIG. 2 is an example network illustrating a communication between command sites and a host device under an enhanced threat level in accordance with an embodiment of the present invention; and

FIG. 3 is a flowchart representing a method for providing secure communications in an electrical power distribution network in accordance with an embodiment of the present invention.

### DETAILED DESCRIPTION

As used herein, the term “module” refers to software, hardware, or firmware, or any combination of these, or any system, process, or functionality that performs or facilitates the processes described herein.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

In a power utility network, utility meters are important components to provide important information to the customer as well as the utility. As meter and communication technology have advanced, it has become possible to remotely read the utility meters. In addition, it has also become possible for utilities to remotely control meters. Such remote control includes remotely turning off a particular subscriber's power, for example. As the power grid becomes “smarter” with advancing technologies, communication between grid devices, customers, and the utilities will increase. As with any communication network, there is a danger that the grid or network will be vulnerable to cyber-attacks.

The embodiments described herein are directed to secure message communication in a network of power grid devices when an enhanced threat level is detected. While embodiments of the invention will be described in the context of energy or electric utility networks, it will be appreciated by those skilled in the art that the method and system can be used for other types of networks as well.

FIG. 1 shows an electrical power distribution network 10 in accordance with an embodiment of the present invention. Electrical power distribution network 10 includes a central coordinator 12 coupled to command sites 14 and host devices 16 via a network 18. A threat response module 20 is coupled to network 18 and communicates directly with all of the control centers 14, central coordinator 12, and host devices 16. In one embodiment, threat response module 20 may be located at the same place as central coordinator 12 or host devices 16 or command sites 14 and stores various programs, including programs for monitoring and testing the network, for example. In order to facilitate the description of the embodiments of the invention, a single threat response module 20, and a small number of command sites 14 and host devices 16 are shown in FIG. 1. However, it should be understood that embodiments of the invention are not limited to these numbers, and that there can be any number of threat response modules 20, command sites 14, and host devices 16 in the network.

In the example discussed herein, central coordinator 12 which is used for system monitoring, demand managing, and operation optimizing can be arranged at and/or hosted by a utility or by any other party. Some implementations may have multiple central coordinators that operate in parallel, and some implementations will have communication between central coordinators.

In one embodiment, command sites 14 may be located at local management offices, distribution substations or transmission substations (not shown). In another embodiment, command sites 14 include a group of control centers (not shown) which during normal operation send configuration command signals to host devices 16 based on communication with central coordinator 12 for performing certain actions or receive certain data from host devices 16. The configuration command signal instructs a host device what action to perform and how to perform i.e., the steps of performing the action. For example, the action to be performed may include reconfiguring a system by turning off one set of reclosers and by switching on another set of reclosers. Each of the control centers may include a processing circuitry for processing data and communication elements such as transmitter and receiver for transmitting and receiving data. Command sites 14 may further forward the aggregated data from all host devices 16 to central coordinator 12 for system monitoring, demand managing, operation optimizing.

In an exemplary embodiment, host devices 16 are utility meters associated with utility customers. In other embodiments, the host devices 16 may be relays, reclosers, line switches, and capacitor banks. Host devices 16 can also include one or more honeypots i.e., a trap set to detect, deflect, or in some manner counteract attempts at unauthorized use of information systems. Host devices 16 can be any host device found in a network environment and include processing circuitry and communication elements such as transmitters and receivers.

The network 18 may be wired, or wireless using such communications as the ZigBee, WiFi, WiMAX, HomePlug architectures, or a hybrid architecture comprising wired and wireless components. Communications between the host devices 16, command sites 14, threat response module 20, and central coordinator 12 include alerts or alarms for security breach, and infrastructure directives such as turning off a device or turning on a device.

At times, an individual or computer attempting to obtain unauthorized entry (Hacker 22) may intercept the messages sent over network 18, and thereby obtain all necessary information to gain full access to command sites 14 and devices 16. Hackers may also be able to trick host devices into believing they are an authorized command site by exploiting known weaknesses or gaining back door entry.

Threat response module 20 includes active or passive programs to probe the network 18 for vulnerability to cyber threats from hacker 22. In one embodiment, threat response module 20 stores known threats and their characteristics in its data store and when such characteristics are detected, threat response module 20 detects the cyber threat. In another embodiment, threat response module 20 detects anomalies in configuration command signals to identify the cyber threat.

More particularly, when threat response module 20 detects a cyber-attack on network 18, it sends out an enhanced threat level communication to command sites 14 and host devices 16. The enhanced threat level communication may be an alert or a control message indicating the actions to be performed under the enhanced threat level. For example, if there is evidence of a penetration, compromise, or co-option of an individual command site 14, there is a significant and dangerous possibility that command site 14 may be attempting to subvert the proper functioning of the power utility by issuing deleterious configuration commands. Under this condition the power utility is operated under an enhanced threat level and threat response module 20 sends out control messages to command sites 14 and host devices 16.

In one embodiment, the control message that is sent out to command sites 14 by threat response module 20 may indicate determine a common configuration command that needs to be executed by host devices 16 under the enhanced threat level. In general, a set of configuration commands which are checked for errors apriori may be stored in data stores of command sites 14. So when threat response module 20 sends the control message to command sites 14, one command site 14 may send a specific configuration command to a second command site 14. If that specific configuration command is present in the data store of the second command site then only that command will be a verified or common configuration command which can be executed by host devices 16. The common configuration command determined by command sites 14 is important because in certain cases the hacker may try to send the deleterious command to host devices 16 through any of the command sites.

The control message from threat response module 20 further indicates to command sites 14 that a threshold number of command sites among the total command sites should send out the verified configuration commands or verified configuration commands and its hash values to host devices 16. It should be noted here that, the hash value is a data resulting from applying a common hash function to a configuration command. In one embodiment, the hash value may be alphanumeric. As a random example, the hash value for a data representing a washing machine may be 3AA whereas the hash value for a configuration command for turning off the washing machine may be 3AA8C9. As will be appreciated by those skilled in the art, a hash function is any algorithm or subroutine that maps a large data to a smaller data set. The hash function algorithms may include trivial hash functions, hashing by checksum functions, and secure hashing for example.

In one embodiment, the threshold number for command sites that should send configuration commands to host devices 16 may be determined by threat response module 20 and communicated to host devices 16. Further, the control message that is sent by threat response module 20 to host devices 16 may indicate to the host devices 16 to execute the configuration commands in configuration command messages received by host devices 16 only if the configuration command messages have originated from the threshold number of command sites 14 and includes same configuration commands or a configuration command and its hash value. Thus, only a certified configuration command is acted on by host devices 16.

In another embodiment, when the enhanced threat level is detected, a command site 14 first sends a configuration command message to threat response module 20 and then threat response module 20 determines the validity of the configuration command in consultation with central coordinator 12. Threat response module 20 may check the validity of the configuration command either by checking the presence of that configuration command in its data store or in the data store of central coordinator 12. Once the configuration command is validated, threat response module 20 instructs a threshold number of command sites to issue the same configuration command or its hash value to host device 16. Individual host devices 16 then determine whether the configuration command messages they have received are from a threshold number of command sites and whether the configuration command message includes information related to a common configuration command. After which host devices 16 execute the configuration command.

In yet another embodiment, the threshold number for command sites is decided apriori and is known to command sites 14 and host devices 16. In another embodiment, command sites 14 or host devices 16 determine and communicate among each other the threshold number for command sites after receiving the enhanced threat level alert. Thus, in these embodiments, threat response module 20 only determines the enhanced threat level and issues a control message indicating presence of the enhanced threat. The command sites 14 and host devices 16 then act on their own in sending and acting on configuration command messages after verifying them.

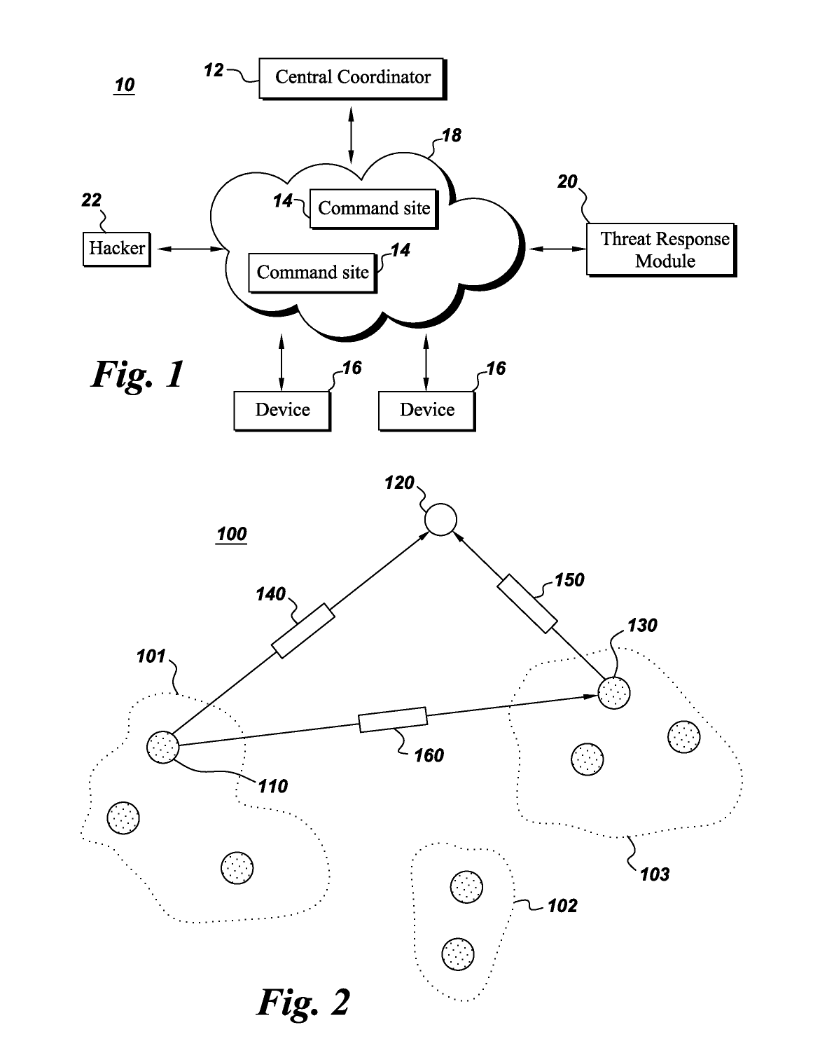

FIG. 2 shows an example network 100 illustrating a communication between command sites and a host device under an enhanced threat level. Network 100 depicts three command sites 101, 102, and 103 and a host device 120. When the enhanced threat level is detected, threat response module 20 (FIG. 1) sends control messages to host device 120 and command sites 101, 102, and 103 which include an enhanced threat alert. In this example, the threshold number for command sites is two, thus, only command sites 101 and 103 take part in communication and command site 102 is not involved. It should be noted however that two is just an example of the threshold number for command sites, and in other cases the number may also be more than two, four, for example.

After receiving the control message from threat response module 20, a control center 110 of command site 101 formulates a configuration command for an enhanced threat and sends it to host device 120 in a configuration command message 140. Control center 110 also sends a message 160 to a control center 130 of command site 103. Message 160 contains the configuration command sent in message 140. Command site 130 then checks validity of the configuration command in message 160 by checking whether that particular configuration command is present in its data store.

Once command site 130 verifies that the configuration command it received from command site 101 is indeed valid, then command site 130 sends a message 150 to module 120. Message 150 includes the configuration command that is carried in message 140 or the hash value of the configuration command carried in message 140.

After receiving messages 140 and 150, host device 120 seeks to certify: (a) that messages 140 and 150 have originated from two distinct groups and (b) that messages 140 and 150 are consistent that is they include same information. It does the latter either by ascertaining that the configuration command carried in message 140 is identical to the configuration command in message 150 or that the hash value carried in message 150 is the correct hash value for the configuration command carried in message 140.

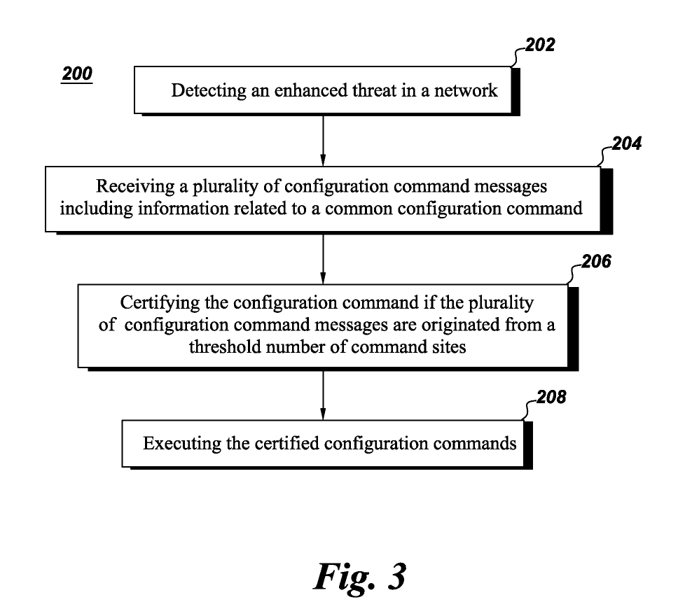

FIG. 3 shows a flowchart 200 representing a method for providing secure communications in an electrical power distribution network in accordance with an embodiment of the present invention. The method includes detecting an enhanced threat in a network at step 202. The enhanced threat may be detected by programs which monitor and test the network and send an alert to command sites and host devices when any network security breach is observed.

When the enhanced threat level is detected, a plurality of configuration command messages are received by host devices 16 (FIG. 1) at step 204. The plurality of configuration command messages includes information relating to a common configuration command such as the configuration command itself or its hash value. A hash value may be obtained by applying a hash function to the configuration command. The hash function algorithms may include trivial hash functions, hashing by checksum functions, and secure hashing for example.

At step 206, the common configuration command is certified if it is determined that the plurality of configuration command messages have originated from a threshold number of command sites. In one embodiment, the threshold number for command sites may be determined a priori and stored in a processing circuitry of command sites or host devices. In other embodiments, a threat response module determines the threshold number for command sites when an enhanced threat is detected and communicates the same to host devices and command sites. In one embodiment, command sites generate common configuration commands after verifying that they are already present in their data stores and then communicate the configuration command messages to host devices 16. In one embodiment, command sites may update their data stores periodically based on system changes. In other embodiments, the threat response module coordinates with central coordinator 12 to analyze the authenticity of a configuration command after receiving it from a command site by checking whether that particular configuration command is present in the data store of central coordinator 12. Finally in step 208, the certified configuration command in step 206 is executed. The configuration command may include performing an action or providing certain information to the command site. For example, the action to be performed may include reconfigure a system by turning off one set of reclosers and by switching on another set of reclosers or turning off a particular subscriber's power.

While some exemplary embodiments of the invention have been described in the context of an electric power network, it will be appreciated by those skilled in the art that the method and system can be used in any communications network.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for providing secure communications in an electrical power distribution network, the method comprising:
detecting a threat level in the electrical power distribution network;
receiving a plurality of configuration command messages including information related to a common configuration command shared by a plurality of command sites over a communication network;
certifying the common configuration command if the plurality of configuration command messages have originated from a threshold number of command sites and have same data; and
executing the certified configuration command.

2. The method of claim 1, wherein detecting the threat level comprises monitoring and testing the electrical power distribution network for a hacker attack.

3. The method of claim 1, wherein information related to a common configuration command comprises a common configuration command and a hash value of the common configuration command.

4. The method of claim 3 wherein the common configuration command includes an action to be performed and steps of performing the action.

5. The method of claim 1, wherein the threshold number for command sites is determined apriori.

6. The method of claim 1, wherein the threshold number for command sites is determined by at least one of a threat response module or the command sites or a host device.

7. The method of claim 1, wherein the common configuration command comprises a verified common configuration command.

8. The method of claim 7, wherein the verified common configuration command is obtained by verifying the authenticity of the common configuration command by the threshold number of command sites.

9. The method of claim 8, wherein verifying the authenticity of the common configuration command includes checking the presence of the common configuration commands in data stores of the threshold number of command sites.

10. The method of claim 7, wherein the verified common configuration command is obtained by verifying the authenticity of the common configuration command by a threat response module in consultation with a central coordinator.

11. A communication system for an electrical power distribution network, comprising:
a threat response module for detecting a threat level in the electrical power distribution network;
a plurality of command sites for transmitting a plurality of configuration command messages including information related to a common configuration command shared by a plurality of command sites to a host device over a communication network;
wherein the host device is configured to:
certify the common configuration command if the plurality of configuration command messages have originated from a threshold number of command sites and have same data; and
execute the certified configuration command.

12. The communication system of claim 11, wherein host devices comprise utility meters associated with utility customers, relays, reclosers, line switches, capacitor banks or honeypots.

13. The communication system of claim 11, wherein the threat response module includes active or passive programs to probe the electrical power distribution network for vulnerability to cyber threats from hacker.

14. The communication system of claim 11, wherein the common configuration command comprises a verified common configuration command.

15. The communication system of claim 14, wherein the verified common configuration command is obtained by verifying the authenticity of the common configuration command by a threshold number of command sites.

16. The communication system of claim 14, wherein the verified common configuration command is obtained by verifying the authenticity of the common configuration command by the threat response module in consultation with a central coordinator.

17. The communication system of claim 11, wherein the information related to a common configuration command comprises a common configuration command and a hash value of the common configuration command.

18. (canceled)

19. The communication system of claim 11, wherein the threshold number for command sites is determined by the threat response module or the command sites or the host device.

20. An apparatus for providing secure communications, the apparatus comprising:
at least one memory that stores computer-executable instructions; and
at least one processor configured to access the at least one memory, wherein the at least one processor is configured to execute the computer-executable instructions to:
detect a threat level in an electrical power distribution network;
receive a plurality of configuration command messages including information related to a common configuration command shared by a plurality of command sites;
certify the common configuration command if the plurality of configuration command messages have originated from a threshold number of command sites and have same data; and
execute the certified configuration command.

21. The apparatus of claim 20, wherein the threshold number for command sites is determined apriori.
